(19) United States
(12) Patent Application Publication
(10) Pub. No.: US 2019/0027035 A1
(43) Pub. Date: Jan. 24, 2019

(54) VEHICLE MONITORING SYSTEM AND METHOD

(71) Applicant: HONGFUJIN PRECISION ELECTRONICS (TIANJIN) CO.,LTD., Tianjin (CN)

(72) Inventor: CHAO-TSUNG FAN, New Taipei (TW)

(21) Appl. No.: 15/829,842

(22) Filed: Dec. 1, 2017

(30) Foreign Application Priority Data
Jul. 21, 2017 (CN) 201710602283.0

(51) Int. Cl. G08G 1/0967; B60T 7/16; G08G 1/01; G08G 1/052; G08G 1/16

(52) U.S. Cl. CPC G08G 1/096725; B60T 7/16; G08G 1/16; G08G 1/052; G08G 1/0133

(57) ABSTRACT

A vehicle monitoring system includes a sensing device, a vehicle information transceiving unit, a vehicle data processing unit, and a braking unit. The sensor assembly obtains information when a vehicle is driven, as to the vehicle itself and road traffic conditions. The information transceiving unit is configured to receive the obtained information. The vehicle data processing unit performs a safety index operation according to the received information. The vehicle data processing unit also determines whether the vehicle is being driven safely according to the safety index. The vehicle data processing unit can control the braking unit to brake the vehicle when determining that the vehicle is not being driven safely. A vehicle monitoring method is also provided.

### FIELD

The subject matter herein generally relates to road traffic safety.

### BACKGROUND

The rearview mirror of a vehicle will have visual blind spots. This and other imperfect systems may make a vehicle prone to accidents unless road safety is constantly being reviewed on an automatic basis.

### BRIEF DESCRIPTION OF THE DRAWINGS

Implementations of the present technology will now be described, by way of example only, with reference to the attached figures.

FIG. 1 is a block diagram of an exemplary embodiment of a vehicle monitoring system with at least one sensing device.

FIG. 2 is a block diagram of the sensing device of FIG. 1.

FIG. 3 is a flow diagram of an exemplary embodiment of a vehicle monitoring method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

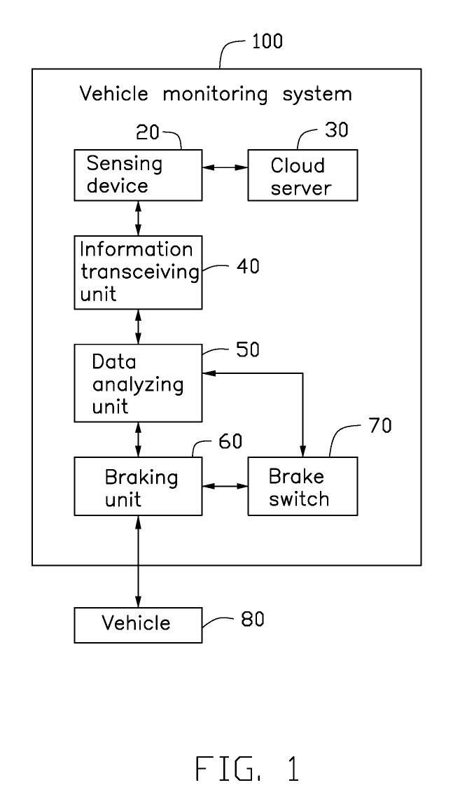

FIG. 1 illustrates a vehicle monitoring system 100 in accordance with an exemplary embodiment. The vehicle monitoring system 100 is configured to monitor conditions concerning and surrounding a vehicle 80.

The vehicle monitoring system 100 comprises a sensing device 20, a cloud server 30, an information transceiving unit 40, a data analyzing unit 50, a braking unit 60, and a brake switch 70.

The cloud server 30 communicates with the sensing device 20. The cloud server 30 obtains a real-time data and analyzes the real-time data. In at least one exemplary embodiment, the real-time data can be a local speed limit for the region. The sensing device 20 is configured to obtain vehicle information when the vehicle 80 is driven. The vehicle information can include a real-time traffic information, a real-time weather information, an unexpected information, and a speed of the vehicle 80 in real time.

The sensing device 20 communicates with the information transceiving unit 40. The information transceiving unit 40 communicates with the data analyzing unit 50. The data analyzing unit 50 communicates with the braking unit 60.

The data analyzing unit 50 communicates with the brake switch 70.

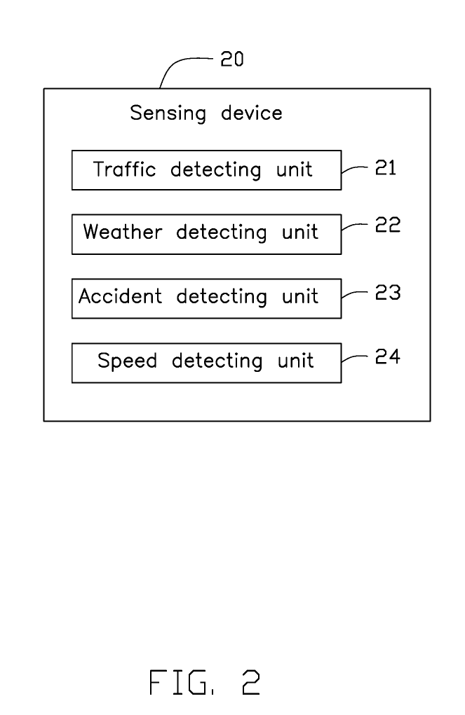

FIG. 2 illustrates that the sensing device 20 comprises a traffic detecting unit 21, a weather detecting unit 22, an accident detecting unit 23, and a speed detecting unit 24.

The traffic detecting unit 21 obtains the real-time traffic information in the course of the vehicle 80 being driven. The real-time traffic information can include whether the road is congested or not and the degree of road congestion.

The weather detecting unit 22 obtains the real-time weather information. The real-time weather information can include temperature, humidity, and wind speed.

The accident detecting unit 23 obtains information as to road condition. The road condition information can include whether there is a traffic accident in front of the vehicle 80 and whether there is an obstacle in front of the vehicle 80.

The speed detecting unit 24 obtains the speed of the vehicle 80 in real time.

The information transceiving unit 40 communicates with the sensing device 20, and obtains the vehicle information of the vehicle 80 from the sensing device 20.

The data analyzing unit 50 obtains the vehicle information from the information transceiving unit 40, and calculates a safety index according to the vehicle information. The data analyzing unit 50 determines whether the vehicle 80 is being driven safely according to the safety index.

For example, a shortest safe braking distance may be a distance of 2 seconds for a current speed. The shortest safety distance of the vehicle 80 at a current speed of 120 km/hour of the vehicle 80 is:

$$\frac{120000 meters}{1 hour} \times \frac{1 hour}{3600 secconds} \times 2 seconds ≅ 66.667 meters ,$$

and the shortest safe braking distance of the vehicle 80 at a current speed of 40 km/h is:

$$\frac{40000 meters}{1 hour} \times \frac{1 hour}{3600 secconds} \times 2 seconds ≅ 22.222 meters .$$

The relationship between the security index S, an actual distance D1, and the shortest safe braking distance D2 is shown as S=D1/D2.

For example, when the current speed of the vehicle 80 is 40 km/h and the actual distance D1 between the vehicle 80 and an obstacle is 24 meters, the safety index

$$S = \frac{D 1}{D 2} = \frac{24 meters}{22.222 meters} ≅ 1.080 .$$

When the weather is sunny and the data analyzing unit 50 determines that the security index S is greater than or equal to a first reference index, the data analyzing unit 50 determines that the vehicle 80 is being driven safely. In at least one exemplary embodiment, the value of the first reference index is 1.

When the weather is sunny and the data analyzing unit 50 determines that the security index S is less than the first reference index, the data analyzing unit 50 determines that the vehicle 80 is not being driven safely.

When the weather is rainy and the data analyzing unit 50 determines that the security index S is greater than or equal to a second reference index, the data analyzing unit 50 determines that the vehicle 80 is being driven safely. In at least one exemplary embodiment, the value of the second reference index is 2.

When the weather is rainy and the data analyzing unit 50 determines that the security index S is less than the second reference index, the data analyzing unit 50 determines that the vehicle 80 is not being driven safely.

In at a second exemplary embodiment, the data analyzing unit 50 compares the local speed limit in the real-time data with the current speed of the vehicle 80.

When the current speed of the vehicle 80 is greater than or equal to the speed limit, the data analyzing unit 50 determines that the vehicle 80 is not being driven safely.

When the current speed of the vehicle 80 is less than the speed limit, the data analyzing unit 50 determines that the vehicle 80 is being driven safely.

When the data analyzing unit 50 determines that the vehicle 80 is not being driven safely, the data analyzing unit 50 controls the braking unit 60 to brake the vehicle 80, the braking unit 60 then controlling the vehicle 80 to decelerate or the braking unit 60 controls the vehicle 80 to brake.

In addition, when the data analyzing unit 50 determines that the vehicle 80 drive is not being driven safely, the data analyzing unit 50 also determines whether the brake switch 70 is turned on. The data analyzing unit 50 controls the brake switch 70 to drive the braking unit 60 to brake the vehicle 80 when the brake switch 70 is turned on.

In at least one exemplary embodiment, when the data analyzing unit 50 determines that the vehicle 80 is not being driven safely according to the security index, the data analyzing unit 50 generates a prompt. The prompt information can warn the driver about unsafe driving and alert the driver to slow down or brake, by a voice warning.

The prompt information may also be given by an indicator light.

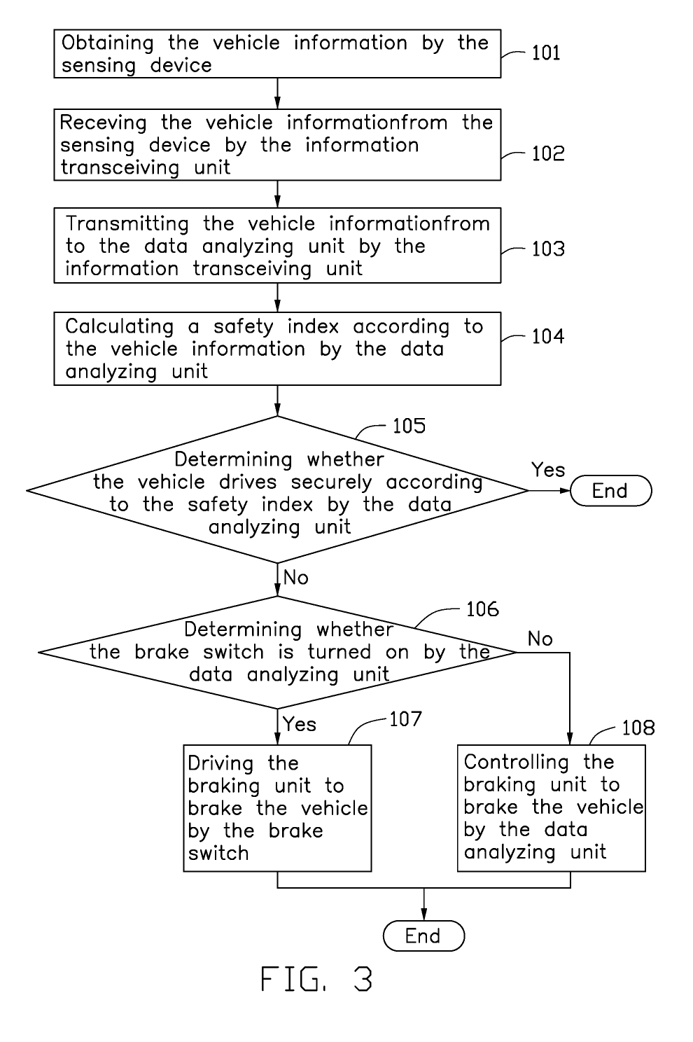

FIG. 3 is a flowchart depicting an exemplary embodiment of a vehicle monitoring method. The method is provided by way of example, as there are a variety of ways to carry out the method. The exemplary method described below can be carried out using the configurations illustrated in FIGS. 1-2, for example, and various elements of these figures are referenced in explaining the example method. Each block shown in FIG. 3 represents one or more processes, methods, or subroutines, carried out in the example method. Furthermore, the illustrated order of blocks is illustrative only and the order of the blocks can change. Additional blocks can be added or fewer blocks may be utilized, without departing from the present disclosure. The example method can begin at block 101.

At block 101, the sensing device 20 is configured to obtain vehicle information when the vehicle 80 is driven. The vehicle information can include a real-time traffic information, a real-time weather information, an unexpected information, and a speed of the vehicle 80 in real time. The traffic detecting unit 21 obtains the real-time traffic information in the course of the vehicle 80 being driven. The real-time traffic information can include whether the road is congested or not and the degree of road congestion. The weather detecting unit 22 obtains the real-time weather information. The real-time weather information can include temperature, humidity, and wind speed. The accident detecting unit 23 obtains the information as to the unforeseen. The unforeseen information can include whether there is a traffic accident in front of the vehicle 80 and whether there is an obstacle in front of the vehicle 80. The speed detecting unit 24 obtains the speed of the vehicle 80 in real time.

At block 102, the information transceiving unit 40 communicates with the sensing device 20 and obtains the vehicle information of the vehicle 80 from the sensing device 20.

At block 103, the information transceiving unit 40 transmits the vehicle information to the data analyzing unit 50.

At block 104, the data analyzing unit 50 obtains the vehicle information from the information transceiving unit 40, and calculates a safety index according to the vehicle information.

For example, the shortest safe braking distance may be a distance of 2 seconds for a current speed. The shortest safety distance of the vehicle 80 at a current speed of 120 km/hour of the vehicle 80 is:

$$\frac{120000 meters}{1 hour} \times \frac{1 hour}{3600 secconds} \times 2 seconds ≅ 66.667 meters ,$$

and the shortest safe braking distance of the vehicle 80 at a current speed of 40 km/h is:

$$\frac{40000 meters}{1 hour} \times \frac{1 hour}{3600 secconds} \times 2 seconds ≅ 22.222 meters .$$

The relationship between the security index S, the actual distance D1, and the shortest safe braking distance D2 is shown as S=D1/D2.

For example, when the current speed of the vehicle 80 is 40 km/h and the actual distance D1 between the vehicle 80 and an obstacle is 24 meters, the safety index

$$S = \frac{D 1}{D 2} = \frac{24 meters}{22.222 meters} ≅ 1.080 .$$

At block 105, the data analyzing unit 50 determines whether the vehicle 80 is being driven safely according to the safety index.

In at least an exemplary embodiment, the block 105 can include: when the data analyzing unit 50 determines that the vehicle 80 is not being driven safely according to the safety index, the data analyzing unit 50 generates a prompt. The prompt can warn the driver bout unsafe driving and alert the driver to slow down or brake, by a voice warning. The prompt information may also be given by an indicator light.

At block 106, the data analyzing unit 50 determines whether the brake switch 70 is turned on, if yes, block 107 is performed, if not, block 108 is performed. the data analyzing unit 50 controls the braking unit 60 to brake the vehicle 80.

At block 107, the brake switch 70 drives the braking unit 60 to brake the vehicle 80.

At block 108, the data analyzing unit 50 controls the braking unit 60 to brake the vehicle 80.

The blocks cloud server 302 and cloud server 306 can be performed simultaneously, so that the data analyzing unit 50 and the brake switch 70 can control the braking unit 60 to brake the vehicle 80 when the brake switch brake switch 70 is turned on.

The exemplary embodiments shown and described above are only examples. Many details are often found in the art such as the other features of vehicle monitoring system and method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A vehicle monitoring method comprising:
obtaining a vehicle information when the vehicle is driven;
receiving the vehicle information;
calculating a safety index according to the vehicle information;
determining whether the vehicle is being driven safely according to the safety index; and
braking the vehicle when the vehicle is not being driven safely.

2. The vehicle monitoring method of claim 1, wherein further comprising:
determining whether a brake switch is turned on, when the vehicle is not being driven safely.

3. The vehicle monitoring method of claim 2, wherein when the brake switch is turned on, the brake switch drives a braking unit to brake the vehicle.

4. The vehicle monitoring method of claim 1, wherein further comprising:
generating a prompt, when the vehicle is not being driven safely.

5. The vehicle monitoring method of claim 1, wherein the vehicle information comprises a real-time traffic information and a real-time weather information.

6. The vehicle monitoring method of claim 5, wherein the vehicle information comprises a speed of the vehicle.

7. A vehicle monitoring system, comprising:
a braking unit;
a sensing device obtaining a vehicle information when the vehicle is driven;
an information transceiving unit receiving the vehicle information; and
a data analyzing unit calculating a safety index according to the vehicle information, and determining whether the vehicle is being driven safely according to the safety index;
wherein when the data analyzing unit determines the vehicle is not being driven safely, the data analyzing unit controls the braking unit to brake the vehicle.

8. The vehicle monitoring system of claim 7, wherein the sensing device communicates with the information transceiving unit, the information transceiving unit communicates with the data analyzing unit, and the data analyzing unit communicates with the braking unit.

9. The device monitoring system of claim 7, wherein the vehicle monitoring system further comprises a brake switch, the data analyzing unit communicates with the brake switch.

10. The device monitoring system of claim 9, wherein the data analyzing unit determines whether the brake switch is turned on when the data analyzing unit determines the vehicle is not being driven safely, and the brake switch drives the braking unit to brake the vehicle.

11. The device monitoring system of claim 10, wherein the data analyzing unit determines the vehicle is not being driven safely, the data analyzing unit generates a prompt.

12. The device monitoring system of claim 7, wherein the sensing device further comprises a traffic detecting unit, the traffic detecting unit obtains real-time traffic information in a course of the vehicle being driven.

13. The device monitoring system of claim 12, wherein the sensing device further comprises a weather detecting unit, the weather detecting unit obtains real-time weather information.

14. The device monitoring system of claim 13, wherein the real-time traffic information comprises whether the road is congested or not and a degree of road congestion.

15. The device monitoring system of claim 14, wherein the real-time weather information comprises temperature, humidity, and wind speed level.

16. The device monitoring system of claim 7, wherein the sensing device further comprises an accident detecting unit, the accident detecting unit obtains the road condition information.

17. The device monitoring system of claim 7, wherein the sensing device further comprises a speed detecting unit, the speed detecting unit obtains a speed of the vehicle in real time.

18. The device monitoring system of claim 16, wherein the road condition information comprises whether there is a traffic accident in front of the vehicle and whether there is an obstacle in front of the vehicle.
